(19) United States
(12) Patent Application Publication
(10) Pub. No.: US 2026/0113608 A1
(43) Pub. Date: Apr. 23, 2026

(54) EMERGENCY PROFILES TO ENABLE EMERGENCY COMMUNICATIONS

(71) Applicant: T-Mobile Innovations LLC, Overland Park, KS (US)

(72) Inventors: Gregory Wade PRESTRIDGE, Olathe, KS (US); Zaheer Mohammed Siddique, Overland Park, KS (US)

(21) Appl. No.: 18/919,699

(22) Filed: Oct. 18, 2024

(51) Int. Cl. H04W 4/90; H04W 4/14; H04W 4/50

(52) U.S. Cl. CPC H04W 4/90; H04W 4/14; H04W 4/50

(57) ABSTRACT

Methods, media, and systems are provided for facilitating carrier-agnostic emergency communications. Specifically, emergency text communications are enabled regardless of a network carrier or being provisioned to communicate via a particular network. An emergency profile can be accessed from the user equipment (UE) to determine if the UE is provisioned for emergency text communications. If not, networks handle the UE as is typical and deny communication via their network if the UE is not provisioned for communication on that network. However, if the emergency profile is present, the UE can be provisioned for communication on the network such that emergency text communications can be communicated via the network that is not associated with the UE.

### SUMMARY

A high-level overview of various aspects of the invention are provided here for that reason, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to facilitate emergency text communications in a carrier agnostic manner, substantially as shown in and/or described in connection with at least one of the figures, and as set forth more completely in the claims.

In aspects set forth herein, and at a high level, the technology described herein relates to carrier agnostic emergency communications. In aspects, carrier agnostic methods for transmitting communications are provided utilizing an emergency profile. The emergency profile may be a universally accepted (i.e., carrier agnostic) profile that is pre-loaded onto user devices. The emergency profile can be identified by the telecommunication network to allow specific emergency communication by the device having an emergency profile.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an example operating environment for facilitating emergency communications in a wireless telecommunication network, in accordance with aspects herein;

FIG. 2 illustrates an example flowchart for facilitating emergency communications, in accordance with aspects herein;

FIG. 3 illustrates another example flowchart for facilitating emergency communications, in accordance with aspects herein;

FIG. 4 illustrates another example flowchart for facilitating emergency communications, in accordance with aspects herein; and

FIG. 5 depicts an example computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. Further, the term “some” may refer to “one or more.” Additionally, an element in the singular may refer to “one or more.”

The term “combination” (e.g., a combination thereof, combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

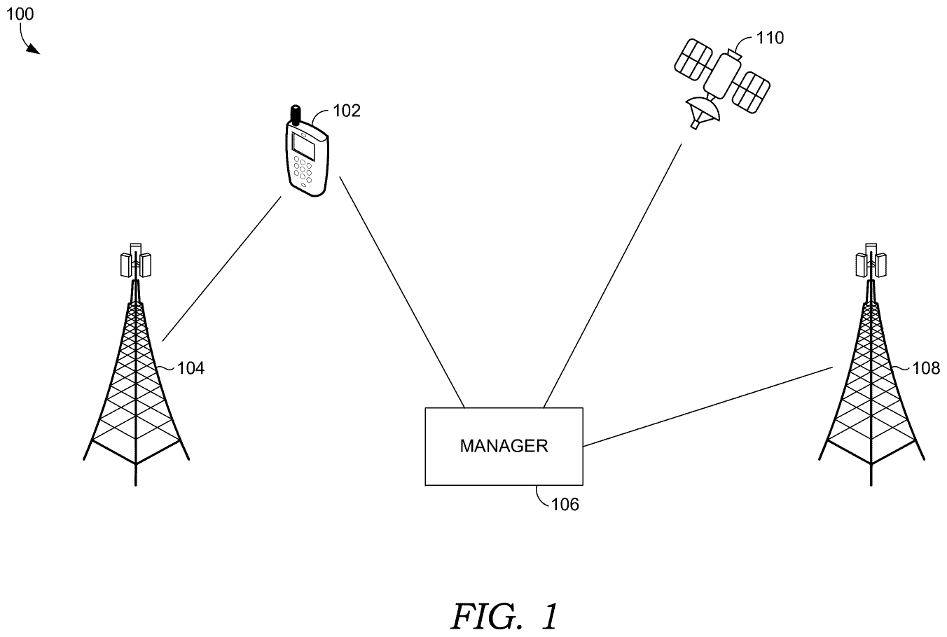

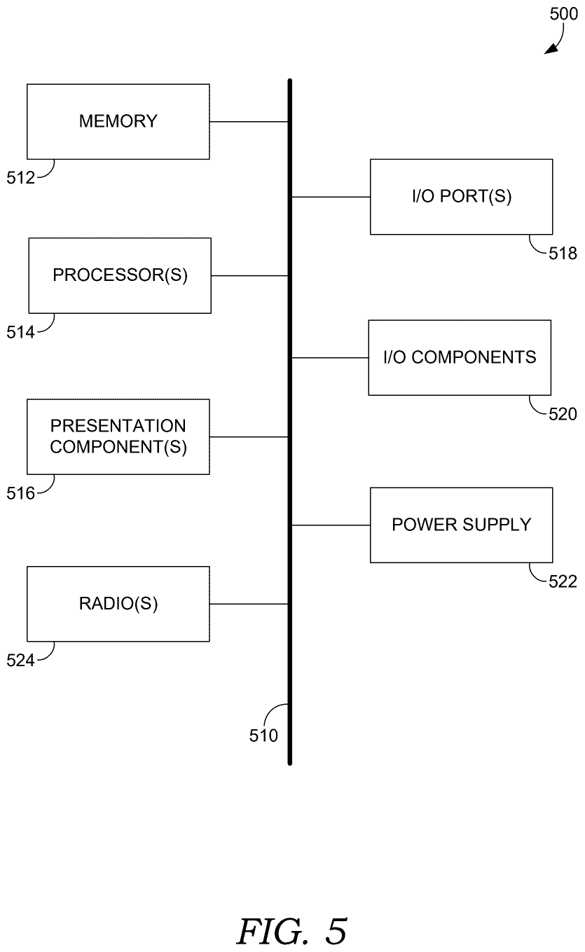

Additionally, a “user device,” as used herein, is a device that has the capability of using a wireless communications network, and may also be referred to as a “computing device,” “mobile device,” “user equipment,” “wireless communication device,” “device,” or “UE.” A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A user device may be, in an embodiment, similar to user device 102 described herein with respect to FIG. 1. A user device may also be, in another embodiment, similar to user device 500, described herein with respect to FIG. 5.

A user device may additionally include internet-of-things devices, such as one or more of the following: a sensor, controller (e.g., a lighting controller, a thermostat), appliances (e.g., a smart refrigerator, a smart air conditioner, and a smart alarm system), other internet-of-things devices, or one or more combinations thereof. Internet-of-things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, other wireless communication devices, or one or more combinations thereof.

In aspects, a user device discussed herein may be configured to communicate using one or more of 3G, 4G (e.g., LTE), 5G, 6G, another generation communication system, or one or more combinations thereof. In some aspects, the user device has a radio that connects with a 4G base station but is not capable of connecting with a higher generation communication system. In some aspects, the user device has components to establish a 5G connection with a 5G gNB, and to be served according to 5G over that connection. In some aspects, the user device may be an E-UTRAN New Radio-Dual Connectivity (ENDC) device.

“Wireless telecommunication services” refer to the transfer of information without the use of an electrical conductor as the transferring medium. Wireless telecommunication services may be provided by one or more telecommunication network providers. Wireless telecommunication services may include, but are not limited to, the transfer of information via radio waves (e.g., Bluetooth®), satellite communication, infrared communication, microwave communication, Wi-Fi, mmWave communication, and mobile communication. Embodiments of the present technology may be used with different wireless telecommunication technologies or standards, including, but not limited to, CDMA 1xAdvanced, GPRS, Ev-DO, TDMA, GSM, WiMax technology, LTE, LTE Advanced, other technologies and standards, or one or more combinations thereof.

A “network” providing the wireless telecommunication services may be a telecommunication network(s), or a portion thereof. A telecommunication network might include an array of devices or components (e.g., one or more base stations). The network can include multiple networks, and the network can be a network of networks. In embodiments, the network is a core network, such as an evolved packet core, which may include at least one mobility management entity, at least one serving gateway, and at least one Packet Data Network gateway. The mobility management entity may manage non-access stratum (e.g., control plane) functions such as mobility, authentication, and bearer management for other devices associated with the evolved packet core.

In some aspects, a network can connect one or more user devices to a corresponding immediate service provider for services such as 5G and LTE, for example. In aspects, the network provides wireless telecommunication services comprising one or more of a voice service, a message service (e.g., SMS messages, MMS messages, instant messaging messages, an EMS service messages), a data service, other types of wireless telecommunication services, or one or more combinations thereof, to user devices or corresponding users that are registered or subscribed to a telecommunication service provider to utilize the one or more services. The network can comprise any communication network providing voice, message, or data service(s), such as, for example, a 1x circuit voice, a 3G network (e.g., CDMA, CDMA2000, WCDMA, GSM, UMTS), a 4G network (WiMAX, LTE, HSDPA), a 5G network, a 6G network, another generation network, or one or more combinations thereof.

Components of the network, such as terminals, links, and nodes (as well as other components), can provide connectivity in various implementations. For example, components of the network may include core network nodes, relay devices, integrated access and backhaul nodes, macro eNBs, small cell eNBs, gNBs, relay base stations, other network components, or one or more combinations thereof. The network may interface with one or more base stations through one or more wired or wireless backhauls. As such, the one or more base stations may communicate to devices via the network or directly. Furthermore, user devices can utilize the network to communicate with other devices (e.g., a user device(s), a server(s), etc.) through the one or more base stations.

As used herein, the term “base station” (used for providing UEs with access to the telecommunication services) or “node” generally refers to one or more base stations, nodes, RRUs control components, and the like (configured to provide a wireless interface between a wired network and a wirelessly connected user device). A base station may comprise one or more nodes (e.g., eNB, gNB, and the like) that are configured to communicate with user devices. In some aspects, the base station may include one or more band pass filters, radios, antenna arrays, power amplifiers, transmitters/receivers, digital signal processors, control electronics, GPS equipment, and the like.

For example, the base station may refer to a base transceiver station, a radio base station, an access point, a radio transceiver, a NodeB, an eNB, a gNB, a Home NodeB, a Home eNodeB, another type base station, or one or more combinations thereof. A node corresponding to the base station may comprise one or more of a macro base station, a small cell or femtocell base station, a relay base station, another type of base station, or one or more combinations thereof. In aspects, the base station may be configured as FD-MIMO, massive MIMO, MU-MIMO, cooperative MIMO, 3G, 4G, 5G, another generation communication system, or one or more combinations thereof. In addition, the base station may operate in an extremely high frequency region of the spectrum (e.g., from 30 GHz to 300 GHz), also known as the millimeter band.

Aspects of the technology described herein may be embodied as, among other things, a method, system, or computer-program product. Accordingly, aspects may take the form of a hardware embodiment, or an aspect combining software and hardware. An aspect that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, users of a telecommunication network may experience situations where emergency communications are needed (e.g., emergency voice calls, emergency messages, etc.). In general, users/user equipment (UE) cannot attach to/utilize a network node unless the UE is provisioned (i.e., approved) to attach to the node. There are current solutions that allow UEs to make emergency voice calls regardless of node provisioning. For instance, a user can initiate an emergency voice call in a carrier-agnostic manner regardless of network provisioning. Thus, a UE that is subscribed to network X can utilize a node of network Y (e.g., a different service provider) regardless of the fact that the UE is not provisioned to utilize network Y. However, this does not extend to emergency messaging. The architecture enabling emergency voice calls cannot simply be applied to messaging/non-voice communications Voice communications are session-based, whereas messaging is not session-based. Thus, it would require a complete reworking of the emergency voice call architecture. For example, for the present solution, tracking an intended recipient of a message is information that is identified. Tracking of senders/recipients of messaging is not currently implemented in emergency voice call architecture.

In addition to sometimes needing to initiate an emergency message from a carrier other than the carrier associated with an originating UE (e.g., location changes, network coverage, etc.), terrestrial coverage may not be available at all for a UE (e.g., natural disaster) such that a non-provisioned node, such as a satellite, may need to be used to communicate emergency messaging.

In aspects herein, emergency profiles are provided that enable a carrier agnostic messaging service. The emergency profile may be included in an eSIM (embedded Subscriber Identity Module) profile as a unique identifier accepted among carrier to enable emergency messaging. The emergency profile can be a public land mobile network (PLMN) identifier that is universally accepted among carriers such that emergency messaging can be enabled. The emergency profile can be embodied as any identifier that is recognized to enable emergency messaging, whether it is a PLMN identifier, a unique generic identifier, an additional IMSI (international mobile subscriber identity), or the like and can be included within an eSIM profile or separately. The emergency profile simply needs to be provisioned to allow emergency messaging (i.e., text messaging) in order to facilitate the carrier-agnostic emergency communication described herein.

In aspects, the emergency profile can be identified in an attach request. When a UE seeks to attach to a network, an attach request is communicated from the UE to the network. The attach request generally includes security credentials, network capability, UE identity information (e.g., IMSI). In a 4G/LTE environment, the Mobile Management Entity (MME) manages the mobility of devices. In a 5G environment, the Access and Mobility Management Function (AMF) handles the registration of UEs to the network. Thus, in aspects, the MME or the AMF can identify the emergency profile in an initial attach request. As previously explained, the emergency profile is only relevant for UEs that are not provisioned for the specific network to which they are attaching. If a user is already provisioned to that network, no special functions are needed in order to enable text communications. Rather, if the user is not provisioned to access the network, the present solution is necessary to avoid the UE being denied access to the network.

Upon identifying that the UE is associated with an emergency profile, the UE is provisioned to initiate emergency text communications. An emergency text communication, as used herein, is a text message that is directed to a predetermined emergency contact as the recipient (e.g., 911, 112, 000, etc.). A list of predetermined emergency contacts may be managed by the networks to ensure that only emergency text communications are being communicated utilizing the emergency profile. In other words, the predetermined emergency contacts that are approved are not managed by users to avoid users including personal contacts (e.g., friends, family, etc.) and sending text communications, thereby abusing the ability to access any network for emergency text communications. The network can identify the intended recipient of any text communication to determine that the text communication is an emergency text communication.

Once the determination is made that the UE is associated with an emergency profile and the text communication is an emergency text communication, the network can allow transmission of the emergency text communication.

In other aspects, UEs can be allowed universal attachment to a network, but the emergency profile is identified upon attempting any communication/trying to utilize services. Put simply, all UEs could attach to the network and an emergency profile validation check would be performed upon the UE attempting to use the network. At that point, the system would handle the provisioning as described above. If the emergency profile is not present, the UE can be removed from the network. If the emergency profile is present, a determination is made as to whether the text communication is an emergency text communication, based on the recipient, and transmission of the emergency text communication is granted while transmission of a non-emergency text communicated is denied.

In additional aspects, a unique identifier within the emergency profile can be mapped to the UE such that UE information is accessible to the operator of the network utilized to initiate the emergency text messaging. For instance, assume that User A is a customer of Network A but initiates an emergency text communication via Network B. Network B does not have any information on the UE since it is not an active customer. The identifier within the emergency profile could allow the network operator of Network B to access UE information, such as a phone number, in order to contact the UE in the event of, for instance, disconnection. This could apply to voice calls as well when a user initiates an emergency voice call on Network A but is not provisioned on that network. Network A then has no callback number to reach the UE if necessary.

There are many advantages to the aspects provided herein, for example being able to allow transmission of emergency text communications (e.g., text messages) in a carrier-agnostic manner ensures that emergency communications are always available to users. There may be situations where a user needs to contact emergency services but cannot make a voice call (e.g., the user is not able to speak, the user does not want to alert someone else of the initiation of an emergency call, and the like). By providing carrier-agnostic communication of emergency text communications, users are provided with more options to contact emergency services in times of need. Additionally, by utilizing satellites (i.e., non-terrestrial nodes) for aspects, a low bandwidth option is provided that results in high throughput; in other words, a larger number of users may utilize a text-only network option in emergency situations due to the lower bandwidth of a satellite node. This may provide more resources to the network, reducing congestion and improving overall performance. There may also be an enhanced user experience since they can access emergency text services when they otherwise would not have been able to communicate the emergency text.

In a first aspect, a method is provided for facilitating carrier-agnostic emergency text communications. The method includes, receiving a request for a user equipment (UE) to attach to a first node of a network; determining whether an emergency profile is associated with the UE; upon determining that the emergency profile is associated with the UE, provisioning the UE to initiate emergency text communication via the first node of the network; receiving a text communication; determining that the text communication is an emergency text communication; and communicating the emergency text communication via the first node of the network.

In a second aspect, a system is provided for facilitating carrier-agnostic emergency text communications. The system includes a node having one or more antennas, the node being associated with a wireless telecommunication network, and one or more processors communicatively coupled with the node. The system further includes computer memory storing computer-usable instructions that, when executed by the one or more processors, perform operations. These operations comprise, receive a request for a user equipment (UE) to attach to the node; determine whether an emergency profile is associated with the UE; upon determining that the emergency profile is associated with the UE, provision the UE to initiate emergency text communication; receive a text communication; determine that the text communication is an emergency text communication; and communicate the emergency text communication via the node.

In a third aspect, one or more non-transitory computer storage media having computer-executable instructions embodied thereon is provided, that when executed by at least one processor, cause the at least one processor to perform a method. The method includes, receiving a text communication from a user equipment (UE); determining whether the UE is associated with an emergency profile; upon determining that the UE is associated with an emergency profile, determining whether the text communication is an emergency text communication; and upon determining that the text communication is an emergency text communication, communicating the emergency text via a node that the UE is not provisioned to utilize for text communication.

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

More specifically, FIG. 1 depicts a system for facilitating carrier-agnostic emergency text communications within a wireless telecommunication network. The system includes components and interactions between the manager 106 and network nodes to a UE 102. Network environment 100 includes nodes 104 and 108 (e.g., base stations), and node 110 (e.g., satellite).

As mentioned, network environment 100 includes user device 102. In network environment 100, user device 102 may take on multiple forms, such as cameras, microphones, sensors, goggles, and glasses, to name a few, or any other device (such as the computing device (500) that communicates via wireless communications to interact with a telecommunication network.

In some aspects, the user device 102 may correspond to computing device 500 in FIG. 5. Thus, user device can include, for example, a display(s), a power source(s) (e.g., a battery), a data store(s), a speaker(s), memory, a buffer(s), a radio(s) and the like. In some implementations, for example, user device 102 comprises a wireless or mobile device with which a wireless telecommunication network(s) can be utilized for communication (e.g., voice and/or data communication). In this regard, the user device 102 can be any mobile computing device that communicates by way of a wireless network, for example, a 3G, 4G, 5G, 6G, LTE, CDMA, or any other type of network. In some cases, user device 102 in network environment 100 can optionally utilize one or more communication channels (not shown) to communicate with other computing devices (e.g., a mobile device(s), a server(s), a personal computer(s), etc.) through the nodes 104, 108, and 110. Nodes shown herein may be a gNodeB, eNodeB, or the like.

The network environment 100 may be comprised of a telecommunication network(s) (now shown), or a portion thereof. A telecommunication network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

The network environment 100 further comprises manager 106. The manager 106 is configured to perform the aspects described herein to facilitate emergency text messaging communication in a carrier-agnostic fashion. The manager 106, for instance, can determine whether emergency profiles are present, whether text communications are emergency text communications, provision devices for emergency text communications, and the like.

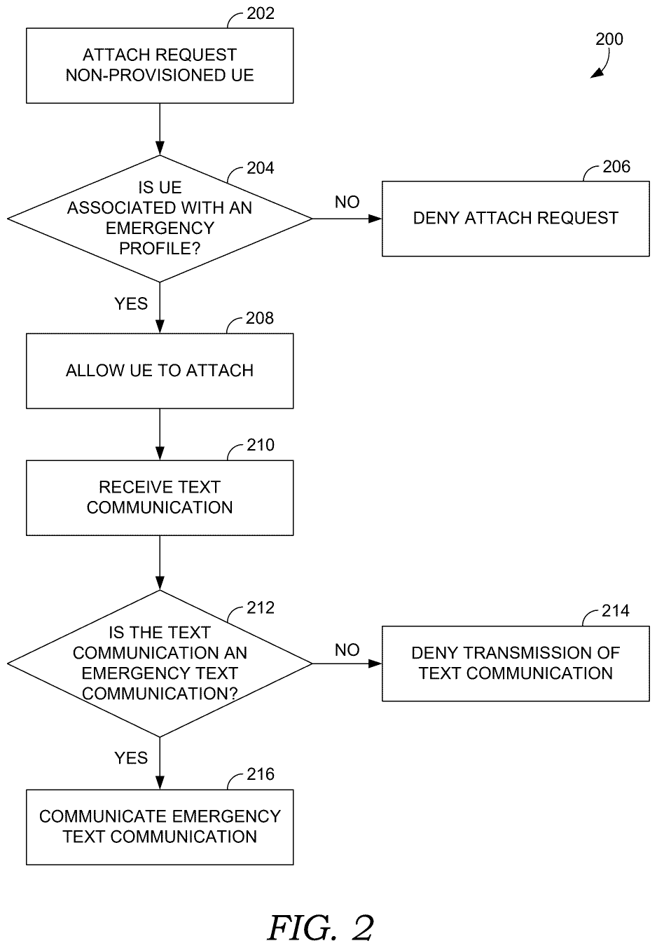

FIG. 2 illustrates an example flowchart of a method 200 for facilitating emergency text communications. Initially, at block 202, an attach request is received. The attach request, in this example, is from a UE is not provisioned to communicate via the network to which it is requesting to attach. This may be because the UE is a customer of another network provider, the UE is a current customer but has an account that has been disabled (e.g., non-payment, etc.), or the like. In any event, the UE is requesting to attach to a network that is not provisioned for text communications on the UE. At block 204, it is determined whether the UE is associated with an emergency profile. As explained above, the emergency profile can be a unique identifier that is specific to a UE but universal to network providers. If an emergency profile is not associated with the UE, the attach request is denied at block 206 since the UE is not provisioned for the network and does not have an emergency profile that would allow emergency communications.

Upon determining that the UE is associated with an emergency profile, the UE is allowed to attach to the network at block 208. At block 210 a text communication is received. A determination is made as to whether the text communication is an emergency text communication at block 212. If not, transmission of the text communication is denied at block 214. An emergency profile only authenticates emergency messaging, not all messaging. Thus, the system 100 evaluates the intended recipient of the communication to determine if it is an emergency messaging communication or not. As described above, a predefined list of emergency contacts is managed by the system 100 and may be location specific (e.g., 911 is emergency services in the United States, while other countries have different emergency codes). Thus, if a text communication is created and intended to be sent to, for instance, a friend that is not included in the predefined list of emergency contacts (emergency recipients), the text communication is denied. If the text communication is determined to be an emergency text communication at block 212, the emergency text communication is communicated/transmitted at block 216.

In other aspects, the system 100 can identify the presence of an emergency profile upon the UE initiating communication on the network, rather than in advance. Thus, the system 100 (e.g., the manager 106) can identify whether or not an emergency profile is present when a messaging communication is initiated.

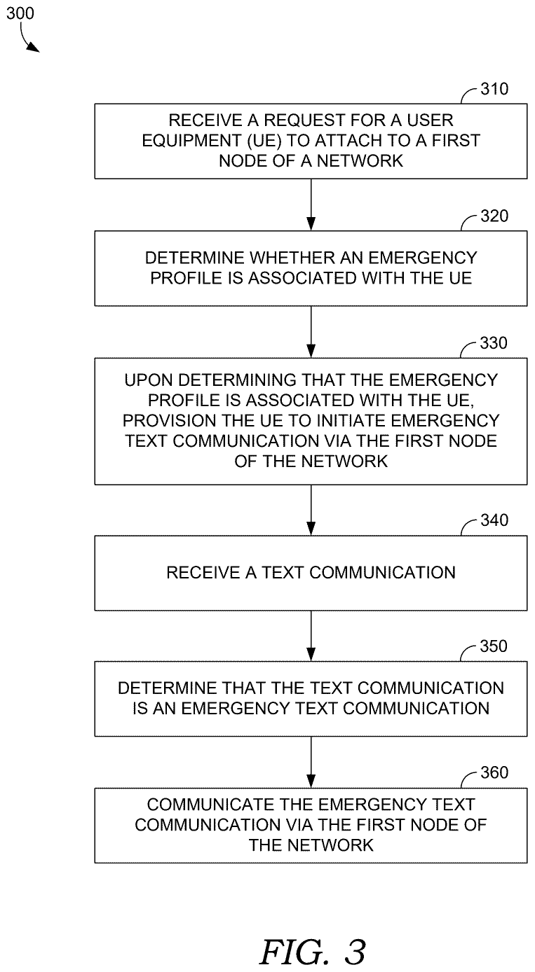

Turning now to FIG. 3, FIG. 3 illustrates another example flowchart of a method 300 for facilitating emergency messaging, in accordance with aspects herein. Initially, at block 310, a request for a user equipment (UE) to attach to the node is received. This request can be received by, for example, a manager of the network environment, such as manager 106. The node, as defined previously, can be an eNodeB, a gNB, and the like. The node may be terrestrial or non-terrestrial (e.g., a satellite). At block 320, it is determined whether an emergency profile is associated with the UE. Upon determining that the emergency profile is associated with the UE, the UE is provisioned to initiate emergency text communication at block 330. At block 340, a text communication is received. It is then determined that the text communication is an emergency text communication at block 350. At block 360, the emergency text communication is transmitted via the node. In instances, a UE can be requesting to attach to a first node when they are only provisioned to communicate via a second node. The first and second nodes may be a non-terrestrial or terrestrial node.

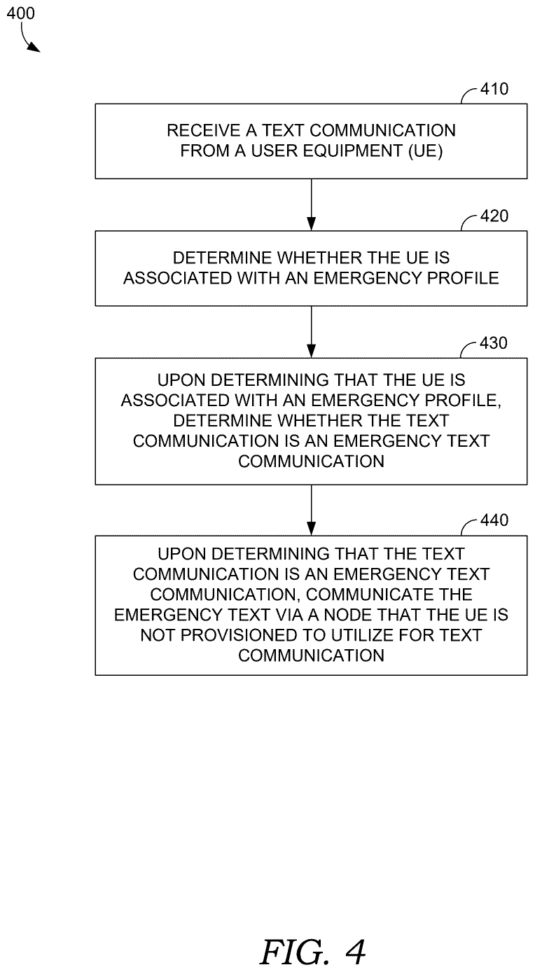

FIG. 4 illustrates another example flowchart of a method 400 for facilitating emergency messaging, in accordance with aspects herein. Initially, at block 410, a text communication is received from a user equipment (UE). At block 420, a determination as to whether the UE is associated with an emergency profile is made. Upon determining that the UE is associated with an emergency profile, it is determined whether the text communication is an emergency text communication at block 430. Upon determining that the text communication is an emergency text communication, the emergency text is communicated via a node that the UE is not provisioned to utilize for text communication at block 440.

Having described the example embodiments discussed above of the presently disclosed technology, an example operating environment of an example user device (e.g., user device 102 of FIG. 1) is described below with respect to FIG. 5. User device 500 is but one example of a suitable computing environment, and is not intended to suggest any particular limitation as to the scope of use or functionality of the technology disclosed. Neither should user device 500 be interpreted as having any dependency or requirement relating to any particular component illustrated, or a particular combination of the components illustrated in FIG. 5.

As illustrated in FIG. 5, example user device 500 includes a bus 510 that directly or indirectly couples the following devices: memory 512, one or more processors 514, one or more presentation components 516, one or more input/output (I/O) ports 518, one or more I/O components 520, a power supply 522, and one or more radios 524.

Bus 510 represents what may be one or more busses (such as an address bus, data bus, or combination thereof). Although the various blocks of FIG. 5 are shown with lines for the sake of clarity, in reality, these blocks represent logical, not necessarily actual, components. For example, one may consider a presentation component, such as a display device, to be an I/O component. Also, processors have memory. Accordingly, FIG. 5 is merely illustrative of an exemplary user device that can be used in connection with one or more embodiments of the technology disclosed herein.

User device 500 can include a variety of computer-readable media. Computer-readable media can be any available media that can be accessed by user device 500 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 512 includes computer storage media in the form of volatile and/or nonvolatile memory. The memory 512 may be removable, non-removable, or a combination thereof. Example hardware devices of memory 512 may include solid-state memory, hard drives, optical-disc drives, other hardware, or one or more combinations thereof. As indicated above, the computer storage media of the memory 512 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 500, or one or more combinations thereof.

The one or more processors 514 of user device 500 can read data from various entities, such as the memory 512 or the I/O component(s) 520. The one or more processors 514 may include, for example, one or more microprocessors, one or more CPUs, a digital signal processor, one or more cores, a host processor, a controller, a chip, a microchip, one or more circuits, a logic unit, an integrated circuit (IC), an application-specific IC (ASIC), any other suitable multi-purpose or specific processor or controller, or one or more combinations thereof. In addition, the one or more processors 514 can execute instructions, for example, of an operating system of the user device 500 or of one or more suitable applications.

The one or more presentation components 516 can present data indications via user device 500, another user device, or a combination thereof. Example presentation components 516 may include a display device, speaker, printing component, vibrating component, another type of presentation component, or one or more combinations thereof. In some embodiments, the one or more presentation components 516 may comprise one or more applications or services on a user device, across a plurality of user devices, or in the cloud. The one or more presentation components 516 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof. For example, the one or more presentation components 516 can present a visualization that compares a plurality of inspections of one or more cores of a central processing unit and a visualization of each task of each of the plurality of inspections.

The one or more I/O ports 518 allow user device 500 to be logically coupled to other devices, including the one or more I/O components 520, some of which may be built in. Example I/O components 520 can include a microphone, joystick, game pad, satellite dish, scanner, printer, wireless device, and the like. The one or more I/O components 520 may, for example, provide a natural user interface (NUI) that processes air gestures, voice, or other physiological inputs generated by a user. In some instances, the inputs the user generates may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with the one or more presentation components 516 on the user device 500. In some embodiments, the user device 500 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 500 may, additionally or alternatively, be equipped with accelerometers or gyroscopes that enable detection of motion. In some embodiments, the output of the accelerometers or gyroscopes may be provided to the one or more presentation components 516 of the user device 500 to render immersive augmented reality or virtual reality.

The power supply 522 of user device 500 may be implemented as one or more batteries or another power source for providing power to components of the user device 500. In embodiments, the power supply 522 can include an external power supply, such as an AC adapter or a powered docking cradle that supplements or recharges the one or more batteries. In aspects, the external power supply can override one or more batteries or another type of power source located within the user device 500.

Some embodiments of user device 500 may include one or more radios 524 (or similar wireless communication components). The one or more radios 524 can transmit, receive, or both transmit and receive signals for wireless communications. In embodiments, the user device 500 may be a wireless terminal adapted to receive communications and media over various wireless networks. User device 500 may communicate using the one or more radios 524 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 524 may facilitate communication via radio frequency signals, frames, blocks, transmission streams, packets, messages, data items, data, another type of wireless communication, or one or more combinations thereof. The one or more radios 524 may be capable of transmitting, receiving, or both transmitting and receiving wireless communications via mmWaves, FD-MIMO, massive MIMO, 3G, 4G, 5G, 6G, another type of Generation, 802.11 protocols and techniques, another type of wireless communication, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A method for facilitating emergency text communications, the method comprising:
receiving a request for a user equipment (UE) to attach to a first node of a network;
determining whether an emergency profile is associated with the UE;
upon determining that the emergency profile is associated with the UE, provisioning the UE to initiate emergency text communication via the first node of the network;
receiving a text communication;
determining that the text communication is an emergency text communication; and
communicating the emergency text communication via the first node of the network.

2. The method according to claim 1, wherein the UE is not provisioned to communicate via the first node.

3. The method according to claim 2, wherein the UE is provisioned to communicate via a second node.

4. The method according to claim 1, wherein the first node is an eNodeB or a gNodeB.

5. The method according to claim 1, wherein the first node is a non-terrestrial node.

6. The method according to claim 1, wherein the emergency text communication includes an emergency recipient from a predefined list of emergency recipients.

7. The method according to claim 1, wherein the UE is provisioned to communicate via a terrestrial second node and the first node is non-terrestrial.

8. The method according to claim 1, wherein the emergency profile includes a unique identifier to map to UE information.

9. The method according to claim 8, wherein the UE information comprises a phone number of the UE.

10. A system for facilitating emergency text communications, the system comprising:
a node having one or more antennas, the node being associated with a wireless telecommunication network;
one or more processors communicatively coupled with the node; and
computer memory storing computer-usable instructions that, when executed by the one or more processors, perform operations comprising:
receive a request for a user equipment (UE) to attach to the node;
determine whether an emergency profile is associated with the UE;
upon determining that the emergency profile is associated with the UE, provision the UE to initiate emergency text communication;
receive a text communication;
determine that the text communication is an emergency text communication; and
communicate the emergency text communication via the node.

11. The system according to claim 10, wherein the UE is not provisioned to communicate via the node.

12. The system according to claim 10, wherein the node is a non-terrestrial node.

13. The system according to claim 11, wherein the UE is provisioned to communicate via a terrestrial node.

14. The system according to claim 10, wherein the emergency text communication includes an emergency recipient from a predefined list of emergency recipients.

15. The system according to claim 10, wherein the emergency profile includes a unique identifier to map to UE information.

16. The system according to claim 10, wherein the UE information comprises a phone number associated with the UE.

17. One or more non-transitory computer storage media having computer-executable instructions embodied thereon, that when executed by at least one processor, cause the at least one processor to perform a method comprising:
receiving a text communication from a user equipment (UE);
determining whether the UE is associated with an emergency profile;
upon determining that the UE is associated with an emergency profile, determining whether the text communication is an emergency text communication; and
upon determining that the text communication is an emergency text communication, communicating the emergency text via a node that the UE is not provisioned to utilize for text communication.

18. The one or more non-transitory computer storage media of claim 17, wherein the node is a non-terrestrial node.

19. The one or more non-transitory computer storage media of claim 17, wherein the node is an eNodeB or a gNodeB.

20. The one or more non-transitory computer storage media of claim 17, wherein the emergency text communication includes an emergency recipient from a predefined list of emergency recipients.
